(19) United States
(12) Patent Application Publication
(10) Pub. No.: US 2026/0127291 A1
(43) Pub. Date: May 7, 2026

(54) SYSTEMS AND METHODS FOR DETERMINING APPLICATION ASSET CHANGES IN DATA SOURCES DURING APPLICATION DEVELOPMENT AND DEPLOYMENT

(71) Applicant: State Farm Mutual Automobile Insurance Company, Bloomington, IL (US)

(72) Inventors: Ryan WILLETT, Cave Creek, AZ (US); Curtis HAMMOCK, Scottsdale, AZ (US); Dennis KAMPEN, Gibson City, IL (US); Lisa HAINES, Fountain Hills, AZ (US); Tyler DEKNECHT, Bloomington, IL (US)

(73) Assignee: State Farm Mutual Automobile Insurance Company, Bloomington, IL (US)

(21) Appl. No.: 18/939,094

(22) Filed: Nov. 6, 2024

(51) Int. Cl. G06F 21/57

(52) U.S. Cl. CPC G06F 21/577; G06F 2221/033

(57) ABSTRACT

Various embodiments of this disclosure relate generally to determining a security risk in one or more application environments. The method comprises: receiving, by one or more processors, a set of data source fields corresponding to an application asset, retrieving, a set of stored data source fields for the application asset from a data store, identifying, one or more change indicators based on the set of stored data source fields for the application asset and the received set of data source fields, determining, whether at least one of the one or more change indicators includes a material change or a non-material change, in response to determining that the at least one change indicator does include a material change, generating, a notification comprising an approval request for the at least one change indicator classified as a material change, and outputting, the notification to a user interface of a user device.

### TECHNICAL FIELD

Various embodiments of this disclosure relate generally to machine-learning based techniques for determining risk in an application environment in response to detected changes to an application asset. In some embodiments, the disclosure relates to systems and methods for training a machine-learning based model to identify and classify the severity of an application risk in an environment.

### BACKGROUND

Cloud-computing platforms allow organizations to develop and host applications with increased scalability without investing in expensive infrastructure. The cloud-computing platform may provide storage and resources to the organization, without the organization needing to invest in a physical infrastructure. However, the scaling and modifying the application may pose a security risk to the organization. Cloud-computing platforms may pose a security risk to organizations that may use sensitive or protected data in applications. For example, an application may be developed and deployed with security protocols met and enforced. However, over the lifetime of the application, the application and/or the application environment may undergo changes that may impact the security risk of the organization. Further, conventional methods may analyze security risks and ensure compliance of the application code when the application code is committed or deployed in the environment. As a result, there is a need for improvements in determining a security risk for application assets developed in and/or hosted by a cloud-computing environment. These improvements may increase security by efficiently identifying and analyzing potential security risks to the organization after the changes to the application asset are deployed. Additionally, the detection may persist throughout the lifetime of the application such that the application is continuously undergoing a risk assessment.

This disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for determining an application environment risk in response to detected changes to an application asset.

In one aspect, an exemplary embodiment of a method for determining a security risk in one or more application environments is disclosed. The method may include receiving, by one or more processors, a set of data source fields corresponding to an application asset. The method may further include, retrieving, by the one or more processors, a set of stored data source fields for the application asset from a data store. The method may further include, identifying, by the one or more processors, one or more change indicators based on the set of stored data source fields for the application asset and the received set of data source fields. The method may further include, determining, by the one or more processors, whether at least one of the one or more change indicators includes a material change or a non-material change. The method may further include, in response to determining that the at least one change indicator does include a material change, generating, by the one or more processors, a notification comprising an approval request for the at least one change indicator classified as a material change. The method may further include outputting, by the one or more processors, the notification to a user interface of a user device.

In a further aspect, an exemplary embodiment of a computer system for determining a security risk in one or more application environments is disclosed. The computer system may include at least one memory storing instructions, one or more processors configured to access the memory and execute the processor-readable instructions, which when executed by the one or more processors configures the one or more processors to perform a plurality of functions. The functions may include receiving, by one or more processors, a set of data source fields corresponding to an application asset. The functions may further include, retrieving, by the one or more processors, a set of stored data source fields for the application asset from a data store. The functions may further include, identifying, by the one or more processors, one or more change indicators based on the set of stored data source fields for the application asset and the received set of data source fields. The functions may further include, determining, by the one or more processors, whether at least one of the one or more change indicators includes a material change or a non-material change. The functions may further include, in response to determining that the at least one change indicator does include a material change, generating, by the one or more processors, a notification comprising an approval request for the at least one change indicator classified as a material change. The functions may further include outputting, by the one or more processors, the notification to a user interface of a user device.

In a further aspect, a non-transitory computer-readable medium containing instructions for determining a security risk in one or more application environments is disclosed. The instructions may include receiving, by one or more processors, a set of data source fields corresponding to an application asset. The instructions may further include, retrieving, by the one or more processors, a set of stored data source fields for the application asset from a data store. The instructions may further include, identifying, by the one or more processors, one or more change indicators based on the set of stored data source fields for the application asset and the received set of data source fields. The instructions may further include, determining, by the one or more processors, whether at least one of the one or more change indicators includes a material change or a non-material change. The instructions may further include, in response to determining that the at least one change indicator does include a material change, generating, by the one or more processors, a notification comprising an approval request for the at least one change indicator classified as a material change. The instructions may further include outputting, by the one or more processors, the notification to a user interface of a user device.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment that may be utilized with techniques presented herein, according to one or more embodiments.

FIG. 2 depicts an exemplary flowchart of an exemplary process of determining an application environment risk in response to detected changes to an application asset, according to one or more embodiments.

FIG. 3 depicts an exemplary flowchart of an exemplary method of determining a security risk in one or more application environments, according to one or more embodiments.

FIG. 4 depicts an example of a computing device that may execute the techniques described herein, according to one or more embodiments.

### DETAILED DESCRIPTION OF EMBODIMENTS

According to certain aspects of the disclosure, methods and systems are disclosed for determining an application environment risk in response to detected changes to an application asset. In some embodiments, the disclosure relates to systems and methods for training a machine-learning based model to identify and classify the severity of the risk in the application environment.

Cloud-computing platforms allow organizations to develop and host applications with increased scalability without investing in expensive infrastructure. The cloud-computing platform may provide storage and resources to the organization, without the organization needing to invest in a physical infrastructure. However, the scaling and modifying the application may pose a security risk to the organization. Cloud-computing platforms may pose a security risk to organizations that may use sensitive or protected data in applications. For example, an application may be developed and deployed with security protocols met and enforced. However, over the lifetime of the application, the application and/or the application environment may undergo changes that may impact the security risk of the organization. Further, conventional methods may analyze security risks and ensure compliance of the application code when the application code is committed or deployed in the environment. As a result, there is a need for improvements in determining a security risk for application assets developed in and/or hosted by a cloud-computing environment. These improvements may increase security by efficiently identifying and analyzing potential security risks to the organization before the changes to the application asset are deployed. Additionally, the detection may persist throughout the lifetime of the application such that the application is continuously undergoing a risk assessment.

One or more machine-learning models and/or generative Artificial Intelligence (“AI”) models may analyze one or more sets of data source fields to determine whether a change indicator is present and, if present, whether the corresponding change is a material change or a non-material change. The machine-learning model may have been previously trained to analyze the set of data source fields and apply one or more materiality rules to the detected changes. One or more sets of data source fields and one or more set of stored data source fields may be input into the machine-learning model to analyze the application asset for a change indicator. The machine-learning model may also determine whether the change indicator corresponds to a material change or non-material change based on the one or more sets of data source fields, change indicator, and the materiality rules for the application asset and/or organization. The machine-learning model may provide the determination to one or more processors of a user device and/or server system. The user device and/or server system may generate a notification comprising an approval request for the material change to the application asset. The notification may be output to a user interface of a user device for review by the user.

Such systems and methods include several advantages. First, the systems and methods may increase security and risk management for an organization. For example, risk assessment may be performed continuously, throughout the lifetime of an application, not just when code is changed and committed. Users may change an application asset via a cloud-computing management console, which may not require the code to be committed. These types of changes may impact risk management for an organization, but may not be assessed by conventional risk management systems and methods. Second, the systems and methods may increase accuracy and efficiency in identifying and managing risks in an application environment. Conventional methods may rely on the self-identification of security risks. The disclosed systems and methods may autonomously detect and analyze changes to an application asset. If a change to an application asset is classified as material, the approval request is automatically output for review and approval.

As will be discussed in more detail below, in various embodiments, systems and methods are described for determining a security risk in one or more application environments. The method may include receiving, by one or more processors, a set of data source fields corresponding to an application asset. The method may further include, retrieving, by the one or more processors, a set of stored data source fields for the application asset from a data store. The method may further include, identifying, by the one or more processors, one or more change indicators based on the set of stored data source fields for the application asset and the received set of data source fields. The method may further include, determining, by the one or more processors, whether at least one of the one or more change indicators includes a material change or a non-material change. The method may further include, in response to determining that the at least one change indicator does include a material change, generating, by the one or more processors, a notification comprising an approval request for the at least one change indicator classified as a material change. The method may further include outputting, by the one or more processors, the notification to a user interface of a user device.

In a further aspect, an exemplary embodiment of a computer system for determining a security risk in one or more application environments is disclosed, the computer system comprising at least one memory storing instructions, and at least one processor configured to execute the instructions to perform operations. The operations may include receiving, by one or more processors, a set of data source fields corresponding to an application asset. The method may further include, retrieving, by the one or more processors, a set of stored data source fields for the application asset from a data store. The method may further include, identifying, by the one or more processors, one or more change indicators based on the set of stored data source fields for the application asset and the received set of data source fields. The method may further include, determining, by the one or more processors, whether at least one of the one or more change indicators includes a material change or a non-material change. The method may further include, in response to determining that the at least one change indicator does include a material change, generating, by the one or more processors, a notification comprising an approval request for the at least one change indicator classified as a material change. The method may further include outputting, by the one or more processors, the notification to a user interface of a user device.

In a further aspect, a non-transitory computer-readable medium may contain instructions that, when executed by a processor, cause the processor to perform operations for determining a security risk in one or more application environments. The operations may include receiving, by one or more processors, a set of data source fields corresponding to an application asset. The method may further include, retrieving, by the one or more processors, a set of stored data source fields for the application asset from a data store. The method may further include, identifying, by the one or more processors, one or more change indicators based on the set of stored data source fields for the application asset and the received set of data source fields. The method may further include, determining, by the one or more processors, whether at least one of the one or more change indicators includes a material change or a non-material change. The method may further include, in response to determining that the at least one change indicator does include a material change, generating, by the one or more processors, a notification comprising an approval request for the at least one change indicator classified as a material change. The method may further include outputting, by the one or more processors, the notification to a user interface of a user device.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In the detailed description herein, references to “embodiment,” “an embodiment,” “one non-limiting embodiment,” “in various embodiments,” etc., indicate that the embodiment(s) described can include a particular feature, structure, or characteristic, but every embodiment might not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

In general, terminology can be understood at least in part from usage in context. For example, terms, such as “and”, “or”, or “and/or,” as used herein can include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, can be used to describe any feature, structure, or characteristic in a singular sense or can be used to describe combinations of features, structures or characteristics in a plural sense. Similarly, terms, such as “a,” “an,” or “the,” again, can be understood to convey a singular usage or to convey a plural usage, depending at least in part upon context. In addition, the term “based on” can be understood as not necessarily intended to convey an exclusive set of factors and can, instead, allow for the existence of additional factors not necessarily expressly described, again, depending at least in part on context.

As used herein, the terms “comprises,” “comprising,” or any other variation thereof are intended to cover a non-exclusive inclusion, such that a process, method, composition, article, or apparatus that comprises a list of elements does not include only those elements, but may include other elements not expressly listed or inherent to such process, method, composition, article, or apparatus. The term “exemplary” is used in the sense of “example” rather than “ideal.” As used herein, the singular forms “a,” “an,” and “the” include plural reference unless the context dictates otherwise. Relative terms such as “about,” “substantially,” and “approximately” refer to being nearly the same as a referenced number or value, and should be understood to encompass a variation of ±5% of a specified amount or value.

As used herein, a “model” or “machine-learning model” generally encompasses instructions, data, and/or a model configured to receive input, and apply one or more of a weight, bias, classification, or analysis on the input to generate an output (e.g., a video, a text-based output, or an audio output). The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine-learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. Any suitable type of training may be used, e.g., stochastic, gradient boosted, random seeded, recursive, epoch or batch-based, etc.

Certain non-limiting embodiments are described below with reference to block diagrams and operational illustrations of methods, processes, devices, and apparatus. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

### Exemplary Environment

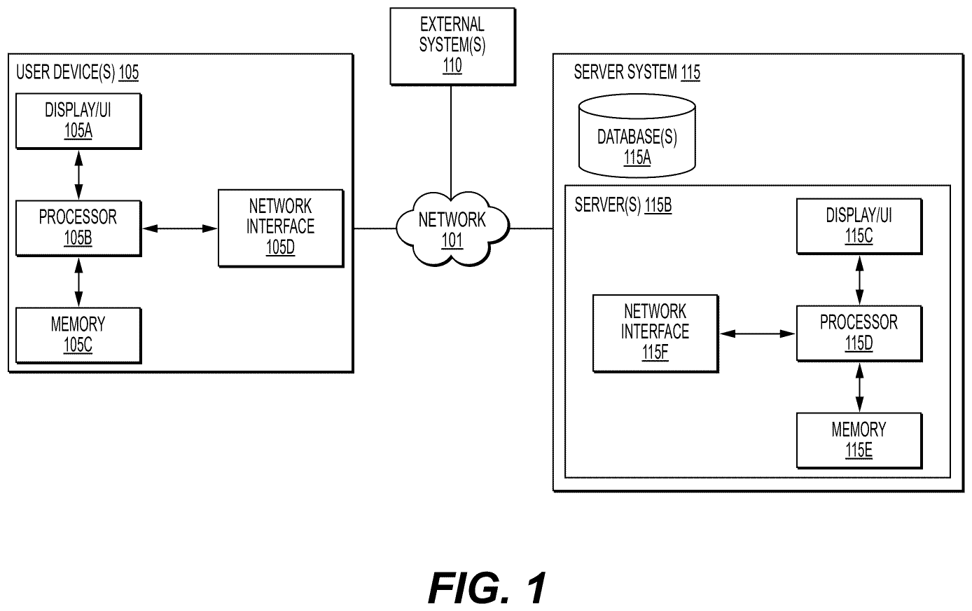

FIG. 1 depicts an exemplary environment 100 that may be utilized with techniques presented herein. One or more user device(s) 105, one or more external system(s) 110, and one or more server system(s) 115 may communicate across a network 101. As will be discussed in further detail below, one or more server system(s) 115 may communicate with one or more of the other components of the environment 100 across network 101. The one or more user device(s) 105 may be associated with a user, e.g., a user developing, editing, and/or utilizing an application asset hosted on an external cloud-computing services that uses sensitive data and/or has access to internal computing services, creating a potential exposure risk for environment 100.

In some embodiments, the components of the environment 100 are associated with a common entity. In some embodiments, one or more of the components of the environment is associated with a different entity than another. The systems and devices of the environment 100 may communicate in any arrangement. As will be discussed herein, systems and/or devices of the environment 100 may communicate in order to generate, train, and/or use a machine-learning model to determine risk associated with one or more application assets hosted by one or more cloud-computing services.

The user device 105 may be configured to enable the user to access and/or interact with other systems in the environment 100. For example, the user device 105 may be a computer system such as, for example, a desktop computer, a mobile device, a tablet, etc. In some embodiments, the user device 105 may include one or more electronic application(s), e.g., a program, plugin, browser extension, etc., installed on a memory of the user device 105.

The user device 105 may include a display/user interface (UI) 105A, a processor 105B, a memory 105C, and/or a network interface 105D. The user device 105 may execute, by the processor 105B, an operating system (O/S) and at least one electronic application (each stored in memory 105C). The electronic application may be a desktop program, a browser program, a web client, or a mobile application program (which may also be a browser program in a mobile O/S), an applicant specific program, system control software, system monitoring software, software development tools, or the like. For example, environment 100 may extend information on a web client that may be accessed through a web browser. In some embodiments, the electronic application(s) may be associated with one or more of the other components in the environment 100. The application may manage the memory 105C, such as a database, to transmit streaming data to network 101. The display/UI 105A may be a touch screen or a display with other input systems (e.g., mouse, keyboard, etc.) so that the user(s) may interact with the application and/or the O/S. The network interface 105D may be a TCP/IP network interface for, e.g., Ethernet or wireless communications with the network 101. The processor 105B, while executing the application, may generate data and/or receive user inputs from the display/UI 105A and/or receive/transmit messages to the server system 115, and may further perform one or more operations prior to providing an output to the network 101.

External systems 110 may be, for example, one or more third party and/or auxiliary systems that integrate and/or communicate with the server system 115. For example, external systems 110 may include one or more cloud-computing platforms and/or services utilized by user device(s) 105 and/or server system 115 to host the application asset(s). In some embodiments, external systems 110 may include one or more machine-learning models and/or generative artificial intelligence (AI) used to determine risk associated with changes to the application asset. External systems 110 may be in communication with other device(s) or system(s) in the environment 100 over the one or more networks 101. For example, external systems 110 may communicate with the server system 115 via API (application programming interface) access over the one or more networks 101, and also communicate with the user device(s) 105 via web browser access over the one or more networks 101.

In various embodiments, the network 101 may be a wide area network (“WAN”), a local area network (“LAN”), a personal area network (“PAN”), or the like. In some embodiments, network 101 includes the Internet, and information and data provided between various systems occurs online. “Online” may mean connecting to or accessing source data or information from a location remote from other devices or networks coupled to the Internet. Alternatively, “online” may refer to connecting or accessing a network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

The server system 115 may include an electronic data system, e.g., a computer-readable memory such as a hard drive, flash drive, disk, etc. In some embodiments, the server system 115 includes and/or interacts with an application programming interface for exchanging data to other systems, e.g., one or more of the other components of the environment.

The server system 115 may include a database 115A and at least one server 415B. The server system 115 may be a computer, system of computers (e.g., rack server(s)), and/or or a cloud service computer system. The server system may store or have access to database 115A (e.g., hosted on a third party server or in memory 115E). The server(s) may include a display/UI 115C, a processor 115D, a memory 115E, and/or a network interface 115F. The display/UI 115C may be a touch screen or a display with other input systems (e.g., mouse, keyboard, etc.) for an operator of the server 115B to control the functions of the server 115B. The server system 115 may execute, by the processor 115D, an operating system (O/S) and at least one instance of a servlet program (each stored in memory 115E).

The server system 115 may be used to determine a potential exposure risk for environment 100 when developing, editing, and/or utilizing an application hosted on one or more external cloud-computing platforms that uses sensitive data and/or has access to internal computing services. The server system 115 may include a machine-learning model and/or instructions associated with the machine-learning model, e.g., instructions for generating a machine-learning model, training the machine-learning model, using the machine-learning model, etc. The server system 115 may include data used by the one or more applications hosted by external system(s) 110 and/or data used to determine risk of external system(s) 110. The machine-learning model may develop rules associated with determining changes when changes to the application asset

In some embodiments, a system or device other than the server system 115 is used to generate and/or train the machine-learning model. For example, such a system may include instructions for generating the machine-learning model, the training data and ground truth, and/or instructions for training the machine-learning model. A resulting trained machine-learning model may then be provided to the server system 115.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to analyze data sources for an indication of change in the application asset, such that the trained machine-learning model is configured to determine whether the change is a non-material change or a material change that may cause an increased or unacceptable level of risk.

In various embodiments, the variables of a machine-learning model may be interrelated in any suitable arrangement in order to generate the output. For example, in some embodiments, the machine-learning model may include signal processing architecture that is configured to identify, isolate, and/or extract features, patterns, and/or structure in a text. For example, the machine-learning model may include one or more convolutional neural network (“CNN”) configured to identify features in the document information data, and may include further architecture, e.g., a connected layer, neural network, etc., configured to detect an change indicator in the data source of an application asset and/or whether the change indicator is a material or non-material change.

Although depicted as separate components in FIG. 1, it should be understood that a component or portion of a component in the environment 100 may, in some embodiments, be integrated with or incorporated into one or more other components. For example, a portion of the display 115C may be integrated into the user device 105 or the like. In some embodiments, operations or aspects of one or more of the components discussed above may be distributed amongst one or more other components. Any suitable arrangement and/or integration of the various systems and devices of the environment 100 may be used.

Further aspects of the machine-learning model and/or how it may be utilized to determine risk for an application asset are discussed in further detail in the methods above. In these methods, various acts may be described as performed or executed by a component from FIG. 1, such as the server system 115, the user device 105, or components thereof. However, it should be understood that in various embodiments, various components of the environment 100 discussed above may execute instructions or perform acts including the acts discussed above and below. An act performed by a device may be considered to be performed by a processor, actuator, or the like associated with that device. Further, it should be understood that in various embodiments, various steps may be added, omitted, and/or rearranged in any suitable manner.

In general, any process or operation discussed in this disclosure that is understood to be computer-implementable, such as the processes illustrated, may be performed by one or more processors of a computer system, such any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

### Exemplary Method for Determining Risk for an Application Asset

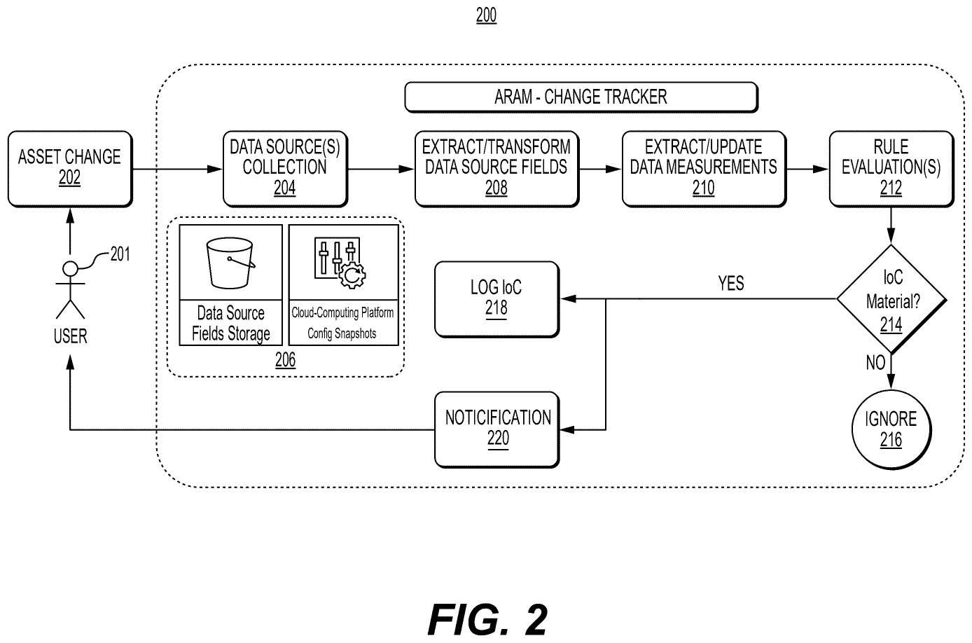

FIG. 2 depicts a flowchart of an exemplary process 200 for determining an application environment risk in response to detected changes to an application asset, according to one or more embodiments. Process 200 may be performed by one or more processors of a server that is in communication with one or more mobile devices and other external system(s) via a network. However, it should be noted that process 200 may be performed by any one or more of the server, one or more user devices, or other external systems.

The process 200 may be implemented for one or more application environments hosted locally, on one or more cloud-computing platforms, and/or using a combination of local and cloud-based resources. Different local and cloud-computing platforms may have specific application assets, data source fields, and methods for capturing an application asset at a given time. However, the functionality of the process 200 may be implemented across application environments and may not depend on specific categories or data associated with application assets, data source fields, and/or methods for capturing an application asset.

The process 200 may include receiving, by one or more processors, a set of data source fields corresponding to an application asset (Blocks 202 and 204) and retrieving, by the one or more processors, a set of stored data source fields for the application asset from a data store (Block 206). For example, an application asset change may trigger the receiving and/or retrieving of the set of data source fields. An application asset may include an application, or portion thereof, hosted via a cloud-computing platform. An application may have monolithic architecture. For example, the application may include a single codebase and may be independent from other applications. Additionally or alternatively, an application may have a microservice architecture. For example, the application services may be divided into sub-components (e.g., microservices), each functioning independently within the application architecture. In a microservice architecture, the application asset may include the entire application or one of the microservice applications. The data source fields may depend on the cloud-computing platform and/or service being used to develop and host applications. For example, some cloud-computing platforms may have one or more services that can be utilized to build and edit the application architecture. The specific platform may include services that may be used by user device(s) 105. Additionally, or alternatively, the server system 115 may automatically determine the set of available data source fields. Process 200 may further include identifying, by the one or more processors, one or more change indicators based on the set of stored data source fields for the application asset and the received set of data source fields (e.g., based on one or more rules) (Block 212).

In some embodiments, process 200 may include extracting and transforming the values of the data source fields into measurement values (Block 210). For example, each of the data source fields may include a state change or a percentage change. In some embodiments, the received set of data source fields may include a new data source field. Process 200 may include determining, by the one or more processors, whether at least one of the one or more change indicators includes a material change or a non-material change (Blocks 214-218). Process 200 may further include generating, by the one or more processors, a notification comprising an approval request for the at least one change indicator classified as a material change. Process 200 may further include outputting, by the one or more processors, the notification to a user interface of a user device (Block 220).

The process 200 may include the one or more user device(s) 105 and/or server system 115 modifying an application asset, which may trigger a notification of an asset change (Block 202). A data source may be point-in-time snapshots of an application asset configuration. For example, the data source may capture the configuration items and/or resources of an application asset and the individual configurations of the configuration items. Data source fields may include the individual configurations of the configuration items and resources of the application asset. Data source fields may be extracted from a data source based on the metadata tags included in the data source file or data container. For example, a data source may be a configuration snapshot in JSON format and the data source fields may be the metadata tags used for the configuration items in the file. In some embodiments, the data source fields may comprise resource tags, configuration item tags, status tags, relationship tags, cost center tags, data classification tags, endpoints, object count, and/or other configuration data fields that may impact risk management. The data source fields may depend on the cloud-computing platform and/or service and the information available.

The process 200 may include the cloud-computing platform collecting/extracting the set of data source fields from the application asset (Block 204). In some embodiments, the active environment of the application asset may be monitored to react to real-time changes in the data source fields of the application environment. For example, when the user device(s) 105 and/or server system 115 initializes a change to the application asset, the system may detect the change in a corresponding data source field.

In some embodiments, different data source fields may be evaluated at different frequencies. Data source fields associated with a high level of risk may be received from the cloud-computing platform for the application asset and evaluated in hourly increments. Less risky data source fields may be evaluated in daily, weekly, monthly, and/or yearly increments according to the risk level associated with the data source field and applied risk management policies.

One or more users may edit and/or update the application asset via a user interface of the external system hosting the pre-deployed application asset and/or deployed application assets. For example, a user device may access a cloud management console corresponding to the application to make edits to the application asset. In some embodiments, the user device may make changes directly to the code and commit the code for deployment. In some embodiments, a change to the application asset or environment may not impact the code. Additionally, or alternatively, a change may not be deployed or committed immediately, but may affect the risk boundary of the application environment regardless. By monitoring data source fields, the system may detect and determine the risk of changes to the pre-deployment application environment and/or before the code has been committed.

The process 200 may include collecting one or more sets of data source fields for the application asset from a data store (e.g., database(s) 115A) (e.g., Block 204). For example, in response to receiving a set of data source fields corresponding to the application asset, the server system may retrieve one or more stored sets of data source fields and/or cloud-computing platform configuration snapshots (e.g., application assets) from one or more databases (e.g., Block 206). The set of stored data source fields may be compared to the current set of data source fields received at Blocks 202 and/or 204 to determine information regarding the changes in the data source fields that may impact the security risk of the application asset.

An application asset may include stored sets of data source fields corresponding to a particular cloud-computing platform, service(s) within the cloud-computing platform, and/or multiple iterations of the stored set of data source fields over time. Based on the application asset, cloud-computing platform, service, and/or time, one or more sets of corresponding sets of stored data source fields may be retrieved.

For example, a specific application asset may have a rule to retrieve the most recent set of stored data source fields when a set of data source fields is retrieved from the database. The retrieved set of stored of data source fields may depend on the service, such as when application assets are hosted on cloud-computing platforms with multiple services and/or when the different services provide different data source fields. In some embodiments, the retrieved set of stored data source fields may include one or more sets with a certain timestamp. For example, one or more set of data source fields from different services within a cloud-computing platform may be stored with the same timestamp.

The process 200 may include extracting and/or transforming the data source fields and one or more sets of stored data (Block 208). In some embodiments, the set of data source fields may originate from one or more snapshots of a server, virtual machine, and/or a storage system of the cloud-computing platform hosting the application asset. As discussed above, in some embodiments the set of data source fields may come directly from the code when the code is deployed or committed. The data source fields may be extracted and transformed into a uniform set of data source fields that may be quantified and/or measurable. The data source fields relevant to the risk management of the organization may be extracted and transformed into a set of data source fields that can be analyzed against the set of stored data source fields. For example, a set of data source fields may be received from a configuration snapshot. The configuration snapshot may include metadata tags, endpoints, and/or classification tags corresponding to individual configurations of the configuration items and resources of the application asset. The metadata tags, endpoints, and/or classification tags may be relevant for the risk management of the specific application may be extracted and transformed into a set of data source fields.

In some embodiments, relevant data source fields may depend on the cloud-computing platform or service, risk management policy of the organization, type of data used by the application asset, and/or a combination thereof. Different cloud-computing platforms and services may present different risks to an organization, which may influence the data source fields extracted for the change indicator analysis. Similarly, different organizations may apply either a stricter or more relaxed risk management policy that influences the number and/or type of data source fields that are extracted. For example, an organization with a more strict risk management policy may extract more data source fields from the cloud-computing platform and/or service, e.g., from the configuration snapshot, than an organization that applies a more relaxed risk management policy.

As discussed above, different data source fields may be evaluated at different frequencies. Therefore, only certain data source fields may be extracted from the data source (e.g., cloud-computing platform or service output) at a given time. Adjusting the frequency of evaluation for each data source based on the risk level creates a more efficient risk evaluation process.

The process 200 may include extracting and/or updating a measurement value that corresponds to each data source field of the set of data source fields (e.g., Block 210). For example, the measurement values may include a state change, a percentage change, and/or a new data source field that was not included in a previous set of stored data source fields. For example, one data source field may include an object count. The measurement value may include the number of objects and/or a percentage (e.g., ratio) change in the object count between the set of data source fields when compared to the set of stored data source fields. In another example, one data source field may include one or more endpoints, such as internet facing endpoints (e.g., regional/edge application programming interface (API) gateways, elastic IP addresses, virtual private network (VPN) gateways, etc.). A new endpoint may have been added to the application asset and therefore the measurement value may include a new data source field, specifically, an internet-facing endpoint.

The measurement value may identify type of data source field (e.g., a new internet-facing endpoint) for evaluation of the change a material or non-material. As discussed, below, different measurement values may establish and change indicator and the specific measurement and or type of change may be material or non-material.

The process 200 may include identifying rules for evaluating the one or more change indicators based on the measurement value (e.g., Block 212). In some embodiments, individual rules may be applied to each data source field based on the risk associated with the specific data source field and the type of measurement value (e.g., state change, percentage change, new data source field).

For example, a data source field may include stored bytes. The measurement value may indicate an increase or decrease in the stored bytes from the set of data source fields when compared to the set of stored data source fields. The rule for the stored byte data source field may correspond to when a measurement value for the data source field establishes a change indicator. For example, a non-zero measurement value in the amount of stored bytes may specify a change indicator. Additionally or alternatively, the rule for stored bytes may indicate a certain percentage or minimum threshold for the measurement value that must be met before a change indicator may be specified. The rules may be individualized for the data source field to apply the risk management policies of the organization.

Further, the extracted and transformed data source fields and corresponding metadata may be stored in a database that may associate a data source field with a rule based on the data source and data source field. The metadata associated with the data source field (e.g., “sk” which may correspond to the data source, the name of the rule, and/or the description which may indicate the change that occurred) may be stored in the database, as well as the measurement value and a change indicator action that may have caused the measurement value. For example, for the stored bytes data source field, the measurement value may be stored as the threshold (e.g., “threshold”: 10), the change indicator may correspond to a modification of the stored bytes, as measured by the 10% increase.

{
“pk”: “rules”,
“sk”: “awsS3StorageLens_s3StoredBytes”,
“name”: “s3StoredBytes”,
“description”: “10% increase in S3 Stored Bytes for AWS Account”,
“enabled”: true,
“notifications”: false,
“csp”: “aws”,
“dataSource”: “awsS3StorageLens”,
“actions”: [“modified”],
“threshold”: 10,
“thresholdUnit”: “percent”,
“recordType”: “rule”
}

In another example, one data source field may correspond to one or more cost center tags, as shown below. The change indicator may include a state change or a new data source field. For example, as shown below, a specific measurement value may not be included because the change in the application asset included the addition of a cost center tag.

{
″pk″: ″rules″,
″sk″: ″awsConfigSnapshots_costCenterTags″,
″name″: ″costCenterTags″,
″description″: ″New ‘cost-center‘ tag value found in AWS Account″,
″enabled″: true,
″notifications″: false,
″csp″: ″aws″,
″dataSource″: ″awsConfigSnapshots″,
″actions″: [″added″],
″recordType″: ″rule″
}

The process 200 may include evaluating the change indicators (IoC) and measurement values for the data source fields to determine whether the change is material or non-material (e.g., Block 214). The system may use one or more machine-learning models and/or generative AI models to create a set of rules for determining whether the one or more change indicators includes a material change or a non-material change. The system may apply one or more materiality rules to the data source field(s) and corresponding measurement value(s) having a change indicator via a machine-learning model to determine whether the change is material or non-material. In some embodiments, the material changes may need further review and approval before being implemented in the application asset due to the risk associated with such material changes.

In some embodiments, a machine-learning model may apply the materiality rules to the data source field(s) and corresponding measurement value(s) having a change indicator. The machine-learning model may apply the rule identified in Block 212 to determine whether the change is material or non-material. The change indicator, measurement value, and/or rule may be input into the machine-learning model. In response, the machine-learning model may provide a determination regarding whether the change indicator and/or measurement value is a material change based on the applied rule.

The process 200 may include determining that the change indicator and measurement value are non-material (e.g., Block 216). A non-material change may indicate that risk associated with the change does not require approval before the change is implemented in the cloud-computing platform and externally accessible by users of the application. As a result, the process 200 may end and the change may be implemented in the application asset. In some embodiments, a subset of the data source fields from a data source may have a change indicator and/or measurement value that the materiality rules are applied to in order to determine a material or non-material change. Additionally or alternatively, no data source fields from a data source may have a change indicator and/or measurement value that may indicate a material change in which the materiality rules should be applied

In some embodiments, the evaluation of non-material changes may occur automatically. For example, data sources may be sent directly to server system 115 and/or user device(s) 105 when a change is made to the application asset without instruction from a user. The removal of self-identified risks via input from a user once the change is made to the application asset increases the security of the application, reduces risk to the organization, and increases efficiency in identifying and mitigating security risk in externally hosted application assets.

The process 200 may include determining (e.g., via the machine-learning model) that the change indicator and/or measurement value corresponds to a material change to the application asset (e.g., Bloc 218). The machine-learning model may correspond to an external system 110 and/or a local machine-learning model of user device(s) 105 and/or server system 115. The material change result may be stored and used to re-train the machine-learning model along with the response to the approval request for the material change. For example, a material change may be identified for a data source field when a threshold value is a different from the threshold value of the rule (e.g., a 6% data source field threshold value may indicate a material change when the threshold for materiality is 5%). In some embodiments, the approval request may be approved each time within the given threshold value, where the threshold value of the rule may be updated to include a consistently-approved threshold value (e.g., the threshold may be changed to 6% rather than 5%).

The process may include generating and outputting a notification that includes an approval request to a user device (e.g., Block 220). In some embodiments, the approval request may identify the application asset, data source, data source field, change indicator, measurement value, and/or any additional information that may assist the review of the approval request.

In some embodiments, in response to the determination from the machine-learning model, the notification may be transmitted in real-time to the user device. Additionally or alternatively, the notification may be generated periodically. The periodic notification may aggregate each material change for the corresponding application asset in a single notification that includes one or more approval requests.

Although FIG. 2 shows example blocks of exemplary process 200, in some implementations, the exemplary process 200 may include additional blocks, fewer blocks, different blocks, or differently arranged blocks than those depicted in FIG. 2. Additionally, or alternatively, two or more of the blocks of the exemplary process 200 may be performed in parallel.

### Exemplary Method for Determining a Security Risk in an Application Environment

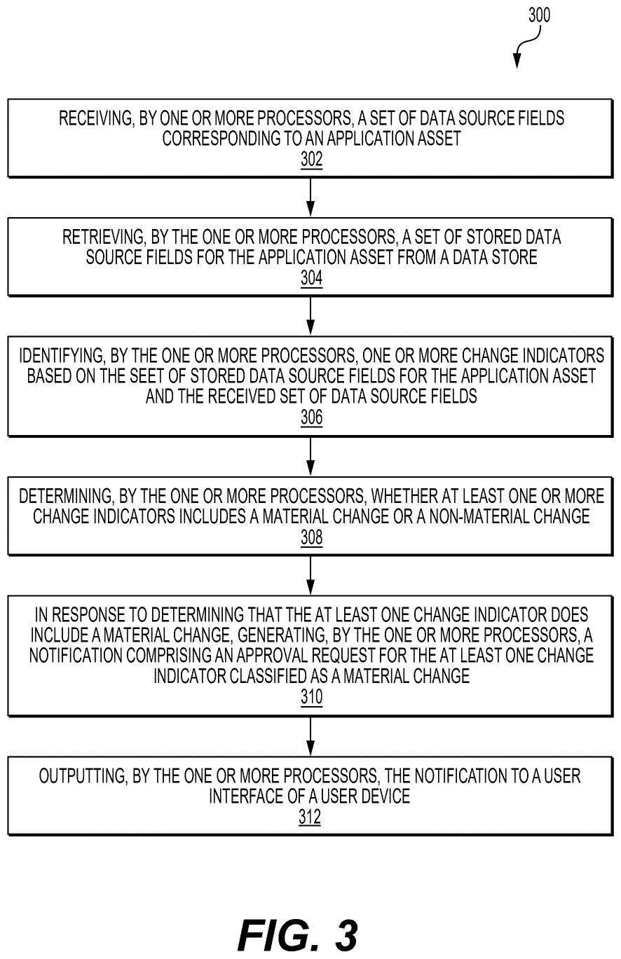

FIG. 3 depicts a flowchart of an exemplary method 300 for determining a security risk in one or more application environments based on detected data source changes, according to one or more embodiments. Method 300 may be performed by one or more processors of a server that is in communication with one or more user devices and other external system(s) via a network. However, it should be noted that method 300 may be performed by any one or more of the server, one or more user devices, or other external systems.

The method 300 may be implemented for one or more application environments hosted locally, on one or more cloud-computing platforms, and/or using a combination of local and cloud-based resources. Different local and cloud-computing platforms may have specific application assets, data source fields, and methods for capturing an application asset at a given time. However, the functionality of the method 300 may be implemented across application environments and may not depend on specific categories or data associated with application assets, data source fields, and/or methods for capturing an application asset.

The method may include receiving, by one or more processors (e.g., processor 105B, processor 115D), a set of data source fields corresponding to an application asset (Step 302). The one or more data source fields may include one or more metadata fields collected by a cloud-computing platform or service of a data source. For example, the set of data source fields may be extracted from a configuration snapshot of the application asset. The configuration snapshot may be autonomously captured periodically to provide a continuation risk analysis of the application asset. In some embodiments, the user may make changes to the application in a cloud-computing management console. The changes may not be deployed or committed, but may impact risk management associated with the application asset. For example, changes made in a management console of the cloud-computing platform may not be committed but may impact risk management. The periodic evaluation of the data source field corresponding to an application asset may prevent risky changes from being inadvertently or mistakenly implemented. For example, the set of data source fields may be received in response to receiving a deployment request for the application asset and/or after receipt of the configuration snapshot for the application asset.

The method may include retrieving, by the one or more processors, a set of stored data source fields for the application asset from a data store (Step 304). The set of stored data source fields may include previously received data source fields, which may have been stored after completion of method 300. For example, a specific application asset may include a rule to retrieve the most recently saved set of stored data source fields when retrieving a set of data source fields. For application assets hosted on cloud-computing platforms with multiple services, where the different services provide different data source fields, the retrieved set of stored of data source fields may be dependent on the service. In some embodiments, the retrieved set of stored data source fields may include one or more sets with a specific timestamp. For example, the one or more set of data source fields from different services within a cloud-computing platform may be stored with the same timestamp.

The method may include identifying, by the one or more processors, one or more change indicators based on the set of stored data source fields for the application asset and the received set of data source fields (Step 306). For example, the change indicators may include actions such as: a new action (first instance of the specific data source field), an added action (new value added to an existing data source field), a modified action (measurement value or threshold is changed), a removed action (value removed from an existing data source field), and/or a deleted action (data source field has been removed). The change indicator may depend on the data source field such that not all change indicators are possible for each data source field. For example, a data source field that may include a state change measurement value may have change indicators that include the following actions: new, added, removed, and/or deleted. A data source field including a ratio change may include change indicators with the following actions: new, modified, and/or deleted.

In some embodiments, the method may further include extracting, by the one or more processors, the updated set of data source field from the application asset; and transforming, by the one or more processors, the updated set of data source fields for the application asset. The data source field may be extracted from the output of the data source (e.g., cloud-computing platform or service output such as a snapshot). The data source field may be extracted from the output and stored in a database. The database may include each data source field for the application asset. In some embodiments, the table may also extract metadata associated with the data source field (e.g., data source field name and description).

The method may further include, determining, by the one or more processors, a measurement value for each data source field of the transformed set of data source fields. For example, the measurement values may include a state change, a percentage change, and/or a new data source field that was not included in a previous set of stored data source fields. The measurement value may be included in the table described above.

In some embodiments, the method may further include, determining, by the one or more processors, a set of rules for evaluating the one or more change indicators based on the measurement value, wherein each rule of the set of rules corresponds to a data source field. Depending on the risk management policies of the organization and the specific data source field, the change indicators may include a tolerance or threshold such that a small change may not be evaluated for a material or non-material change. For example, some data source fields may not be indicators of change for risk management. Additionally or alternatively, some change indicators may have large measurement values before they are evaluated for materiality. Depending on the risk management policies of the organization, any non-zero or state change may establish a change indicator that should be evaluated.

The method may include determining, by the one or more processors, whether at least one of the one or more change indicators includes a material change or a non-material change (Step 308). Material changes may include changes that undergo further review and approval before implementation in the application asset.

In some embodiments, the method may further include, creating, by the one or more processors, a set of rules for determining whether the one or more change indicators include a material change or a non-material change. One or more machine-learning models and/or generative AI models may create a set of rules for determining whether the one or more change indicators include a material change or a non-material change. For example, a machine-learning model may be trained to create and apply materiality rules based on risk management policies, data source fields, and/or measurement values.

The method may further include inputting, by the one or more processors, the change indicators and the set of rules into a machine-learning model, wherein the set of rules may include one or more materiality thresholds, wherein the machine-learning model may be configured to analyze the change indicators against the one or more materiality thresholds to determine whether the change indicators includes a material change or a non-material change. The method may further include, in response to the inputting, receiving, by the one or more processors, a material change notification or a non-material change notification from the machine-learning model.

In some embodiments, the method may further include, logging, by the one or more processors, the one or more change indicators and corresponding measurement value in a database; receiving, by the one or more processors, in real-time, an updated set of data source fields for the application asset based on the previously received set of data source fields; and/or storing, by the one or more processors, the updated set of data source fields for the application asset. For example, the material change determination may be stored along with the change indicator and measurement value in one or more data stores corresponding to one or more internal and/or external systems. Additionally, or alternatively, the stored information may be used to re-train the machine-learning model along with the response to the approval request for the material change. For example, a material change may be identified for a data source field when a threshold value is a different from the threshold value of the rule (e.g., a 6% data source field threshold value may indicate a material change when the threshold for materiality is 5%). In some embodiments, the approval request may be approved each time within the given threshold value, where the threshold value of the rule may be updated to include a consistently-approved threshold value (e.g., the threshold may be changed to 6% rather than 5%).

The method may include, in response to determining that the at least one change indicator does include a material change, generating, by the one or more processors, a notification comprising an approval request for the at least one change indicator classified as a material change (Step 310). In some embodiments, the approval request may identify the application asset, data source, data source field, change indicator, measurement value, and/or any additional information that may assist the review of the approval request.

The method may include outputting, by the one or more processors, the notification to a user interface (e.g., display/UI 105A) of a user device (Step 312). Additionally or alternatively, the notification may be generated periodically. The periodic notification may aggregate each material change for corresponding to the application asset in a single notification comprising one or more approval requests.

Although FIG. 3 shows example blocks of exemplary method 300, in some implementations, the exemplary process 300 may include additional blocks, fewer blocks, different blocks, or differently arranged blocks than those depicted in FIG. 3. Additionally, or alternatively, two or more of the blocks of the exemplary method 300 may be performed in parallel.

### Exemplary Device

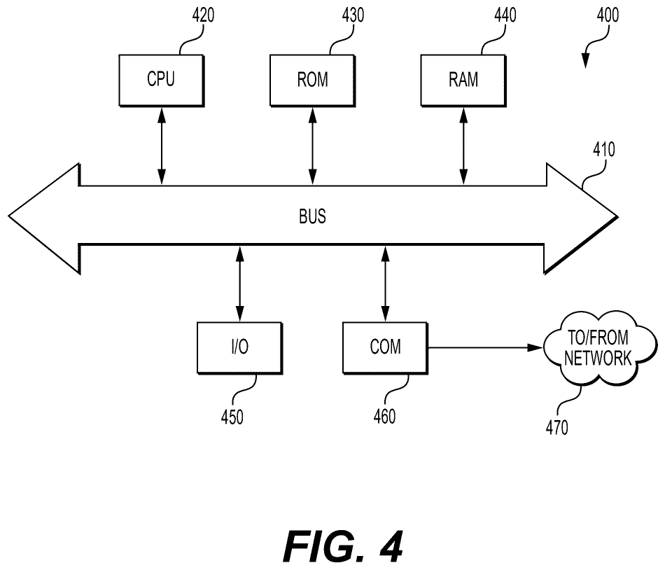

FIG. 4 is a simplified functional block diagram of a computer 400 that may be configured as a device for executing the methods and processes of FIGS. 2-3, according to exemplary embodiments of the present disclosure. For example, device 400 may include a central processing unit (CPU) 420. CPU 420 may be any type of processor device including, for example, any type of special purpose or a general-purpose microprocessor device. As will be appreciated by persons skilled in the relevant art, CPU 420 also may be a single processor in a multi-core/multiprocessor system, such system operating alone, or in a cluster of computing devices operating in a cluster or server farm. CPU 420 may be connected to a data communication infrastructure 410, for example, a bus, message queue, network, or multi-core message-passing scheme.

Device 400 also may include a main memory 440, for example, random access memory (RAM), and also may include a secondary memory 430. Secondary memory 430, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 430 may include other similar means for allowing computer programs or other instructions to be loaded into device 400. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 400.

Device 400 also may include a communications interface (“COM”) 460. Communications interface 460 allows software and data to be transferred between device 400 and external devices. Communications interface 460 may include a modem, a network interface (such as an Ethernet card), a communications port, a PCMCIA slot and card, or the like. Software and data transferred via communications interface 460 may be in the form of signals, which may be electronic, electromagnetic, optical, or other signals capable of being received by communications interface 460. These signals may be provided to communications interface 460 via a communications path of device 400, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 400 also may include input and output ports 450 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the general description and the detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of +10% of a stated or understood value.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model/system is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine-learning techniques, such as linear regression, logistical regression, random forest, gradient boosted machine (GBM), decision tree, gradient boosting in a decision tree, deep learning, and/or a deep neural network. Supervised and/or unsupervised training may be employed. For example, supervised learning may include providing training data and classifications corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for determining a security risk in one or more application environments, the computer-implemented method comprising:
receiving, by one or more processors, a set of data source fields corresponding to an application asset;
retrieving, by the one or more processors, a set of stored data source fields for the application asset from a data store;
identifying, by the one or more processors, one or more change indicators based on the set of stored data source fields for the application asset and the received set of data source fields;
determining, by the one or more processors, whether at least one of the one or more change indicators includes a material change or a non-material change;
in response to determining that the at least one change indicator does include a material change, generating, by the one or more processors, a notification comprising an approval request for the at least one change indicator classified as a material change; and
outputting, by the one or more processors, the notification to a user interface of a user device.

2. The computer-implemented method of claim 1, wherein the receiving the set of data source fields is in response to receiving a deployment request for the application asset.

3. The computer-implemented method of claim 1, further comprising:
extracting, by the one or more processors, the updated set of data source fields from the application asset;
transforming, by the one or more processors, the updated set of data source fields for the application asset; and
determining, by the one or more processors, a measurement value for each data source field of the transformed set of data source fields.

4. The computer-implemented method of claim 3, wherein the measurement value comprises a state change, a percentage change, and/or a new data source field.

5. The computer-implemented method of claim 3, further comprising:
determining, by the one or more processors, a set of rules for evaluating the one or more change indicators based on the measurement value, wherein each rule of the set of rules corresponds to a data source field.

6. The computer-implemented method of claim 1, the method further comprising:
creating, by the one or more processors, a set of rules for determining whether the one or more change indicators include the material change or the non-material change.

7. The computer-implemented method of claim 6, wherein the creating includes:
inputting, by the one or more processors, the change indicators and the set of rules into a machine-learning model, wherein the set of rules includes one or more materiality thresholds, wherein the machine-learning model is configured to analyze the change indicators against the one or more materiality thresholds to determine whether the change indicator includes a material change or a non-material change; and
in response to the inputting, receiving, by the one or more processors, a material change notification or a non-material change notification from the machine-learning model.

8. The computer-implemented method of claim 1, further comprising:
logging, by the one or more processors, the one or more change indicators and corresponding measurement value in a database;
receiving, by the one or more processors, in real-time, an updated set of data source fields for the application asset based on the previously received set of data source fields; and
storing, by the one or more processors, the updated set of data source fields for the application asset.

9. The computer-implemented method of claim 1, wherein the one or more data source fields include one or more metadata fields collected by a cloud-computing environment of a data source.

10. A computer system for determining a security risk in one or more application environments, the computer system comprising:
a memory having processor-readable instructions stored therein;
one or more processors configured to access the memory and execute the processor-readable instructions, which when executed by the one or more processors configures the one or more processors to perform a plurality of functions, including functions for:
receiving, by one or more processors, a set of data source fields corresponding to an application asset;
retrieving, by the one or more processors, a set of stored data source fields for the application asset from a data store;
identifying, by the one or more processors, one or more change indicators based on the set of stored data source fields for the application asset and the received set of data source fields;
determining, by the one or more processors, whether at least one of the one or more change indicators includes a material change or a non-material change;
in response to determining that the at least one change indicator does include a material change, generating, by the one or more processors, a notification comprising an approval request for the at least one change indicator classified as a material change; and
outputting, by the one or more processors, the notification to a user interface of a user device.

11. The computer system of claim 10, wherein the receiving the set of data source fields is in response to receiving a deployment request for the application asset.

12. The computer system of claim 10, further comprising:
extracting, by the one or more processors, the updated set of data source fields from the application asset;
transforming, by the one or more processors, the updated set of data source fields for the application asset; and
determining, by the one or more processors, a measurement value for each data source field of the transformed set of data source fields.

13. The computer system of claim 12, wherein the measurement value comprises a state change, a percentage change, and/or a new data source field.

14. The computer system of claim 12, further comprising:
determining, by the one or more processors, a set of rules for evaluating the one or more change indicators based on the measurement value, wherein each rule of the set of rules corresponds to a data source field.

15. The computer system of claim 10, further comprising:
creating, by the one or more processors, a set of rules for determining whether the one or more change indicators include the material change or the non-material change.

16. The computer system of claim 15, further comprising:
inputting, by the one or more processors, the change indicators and the set of rules into a machine-learning model, wherein the set of rules includes one or more materiality thresholds, wherein the machine-learning model is configured to analyze the change indicators against the one or more materiality thresholds to determine whether the change indicator includes a material change or a non-material change; and
in response to the inputting, receiving, by the one or more processors, a material change notification or a non-material change notification from the machine-learning model.

17. The computer system of claim 10, further comprising:
logging, by the one or more processors, the one or more change indicators and corresponding measurement value in a database;
receiving, by the one or more processors, in real-time, an updated set of data source fields for the application asset based on the previously received set of data source fields; and
storing, by the one or more processors, the updated set of data source fields for the application asset.

18. The computer system of claim 10, wherein the one or more data source fields include one or more metadata fields collected by a cloud-computing environment of a data source.

19. A non-transitory computer-readable medium containing instructions for determining a security risk in one or more application environments, the instructions comprising:
receiving, by one or more processors, a set of data source fields corresponding to an application asset;
retrieving, by the one or more processors, a set of stored data source fields for the application asset from a data store;
identifying, by the one or more processors, one or more change indicators based on the set of stored data source fields for the application asset and the received set of data source fields;
determining, by the one or more processors, whether at least one of the one or more change indicators includes a material change or a non-material change;
in response to determining that the at least one change indicator does include a material change, generating, by the one or more processors, a notification comprising an approval request for the at least one change indicator classified as a material change; and
outputting, by the one or more processors, the notification to a user interface of a user device.

20. The non-transitory computer-readable medium of claim 19, wherein the receiving the set of data source fields is in response to receiving a deployment request for the application asset.
